(19) United States
(12) Patent Application Publication
(10) Pub. No.: US 2024/0180783 A1
(43) Pub. Date: Jun. 6, 2024

(54) TABLET DISPENSER

(71) Applicant: Eli Lilly and Company, Indianapolis, IN (US)

(72) Inventors: Greeshma GIRIJAKUMARI, Thiruvananthapuram (IN); Praveen KADNI, Bengaluru (IN); Ankur KODAVANTI, Visakhapatnam (IN); Joshin SAHADEVAN, Bangalore (IN); Lakshmana SIDDAPPA, Bangalore (IN)

(21) Appl. No.: 18/552,897

(22) PCT Filed: Apr. 26, 2022
(86) PCT No.: PCT/US2022/026260

§ 371 Date: Sep. 28, 2023

Related U.S. Application Data
(60) Provisional application No. 63/180,720, filed on Apr. 28, 2021.

(51) Int. Cl. A61J 7/00; A61J 1/14

(52) U.S. Cl. CPC A61J 7/0076; A61J 1/1418

(57) ABSTRACT

Tablet dispensers and methods for use are provided herein. In some embodiments, a tablet dispenser has a dosage actuator that permits a user to select a desired dosage to dispense from the dispenser. Changing the selected dosage may change a volume of a collection space of the tablet dispenser. The tablet dispenser may be configured to attach to a tablet container. With the tablet dispenser attached to the tablet container, a user may tilt the tablet container, causing tablets from the tablet container to fall into the collection space. The tablets from the collection space may then be dispensed out of the tablet dispenser for administration to a patient.

### FIELD

Disclosed embodiments are related to tablet dispensing devices and related methods of use.

### BACKGROUND

Tablets, also referred to as pills or capsules, are popular dosage forms. A common and convenient route of drug delivery is by oral ingestion, and tablets are commonly orally ingested. Tablets may also be administered via other routes of administration, such as sublingually (under the tongue), buccally (between the cheek and gum), rectally, or intravaginally.

Mini-tablets, also referred to as micro-tablets, are tablets having a smaller size than conventional tablets. Due to their small size, mini-tablets may be easier to swallow than conventional tablets, and thus may be useful for administration to pediatric patients and/or patients with swallowing difficulties (e.g., dysphagia). In some instances, mini-tablets may be mixed into foods and/or dissolved into liquids prior to administration to facilitate administration. Also due to their small size, mini-tablets may allow for dose flexibility. Mini-tablets can be applied with different functional coatings to achieve modified release profiles.

### SUMMARY

According to an illustrative embodiment of the present disclosure, a tablet dispenser is disclosed including a cap configured to attach to a tablet container and a collection space coupled to the cap and configured to receive tablets from the tablet container. The collection space has a volume that is adjustable. The tablet dispenser further includes a dosage actuator. Actuation of the dosage actuator to change a selected dosage changes the volume of the collection space.

According to another illustrative embodiment of the present disclosure, a tablet dispenser is disclosed including a cap configured to attach to a tablet container and an outlet through which tablets are dispensed from the cap. The cap has an opening configured to receive tablets from the tablet container. The tablet dispenser further includes a pathway within the cap and a plurality of pegs positioned in the pathway. The pathway connects the opening to the outlet.

According to yet another illustrative embodiment of the present disclosure, a method of dispensing a tablet from a tablet dispenser is disclosed. The method includes coupling the tablet dispenser to a tablet container, setting a dosage using a dosage actuator to set a volume of a collection space, tilting the tablet dispenser while the tablet container is attached to the tablet dispenser to permit a tablet to move from the tablet container to the collection space, and dispensing the tablet from the collection space out of the tablet dispenser.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front, right perspective view of one embodiment of a tablet dispenser;

FIG. 2 is rear, right perspective view of the tablet dispenser of FIG. 1;

FIG. 3 depicts the tablet dispenser of FIG. 1 engaged with a tablet container to form a tablet dispenser and tablet container assembly;

FIG. 4 is an exploded view of the tablet dispenser and tablet container assembly of FIG. 3;

FIG. 5 is a perspective view of a cap of a tablet dispenser;

FIG. 6A is a cutaway view of the cap of FIG. 5, taken along line 6-6 of FIG. 5;

FIG. 6B is a cross-sectional view of the cap of FIG. 5, taken along line 6-6 of FIG. 5;

FIG. 6C is a cross-sectional view of the cap of FIG. 5, taken along line C-C of FIG. 6B;

FIG. 7A is a cross-sectional view of a tablet dispenser and tablet container assembly, where the tablet dispenser is in a first configuration;

FIG. 7B is a cross-sectional view of a tablet dispenser and tablet container assembly, where the tablet dispenser is in a second configuration;

FIG. 8 illustrates a step of removing a cap from a tablet container according to one embodiment of using a tablet dispenser;

FIG. 9 illustrates a step of engaging a tablet dispenser to the tablet container of FIG. 8;

FIG. 10 illustrates a step of actuating a dosage actuator to select a desired dosage;

FIG. 11 is a cross-sectional view of the dosage actuator and collector of FIG. 10, taken along line 11-11 of FIG. 10;

FIG. 12 illustrates a step of rotating a collector relative to the tablet container to a collection configuration;

FIG. 13 illustrates a step of tapping a tablet dispenser and/or a tablet container to urge tablets to move from the tablet container to the collector;

FIG. 14 illustrates features of the tablet dispenser through which tablets move;

FIG. 15 illustrates a step of rotating the collector relative to the tablet container to a dispensing configuration;

FIG. 16 illustrates a step of inverting the tablet dispenser to dispense tablets out of the tablet dispenser;

FIG. 17 is a perspective view of a safety lock according to one embodiment;

FIG. 18 illustrates operation of the safety lock of FIG. 18;

FIG. 19 is an exploded view of a cap, safety lock and collector, with the spring arms of the safety lock hidden from view for clarity;

FIG. 20 is a top perspective view of the safety lock of FIG. 19, with the spring arms hidden from view for clarity;

FIG. 21 is a bottom perspective view of the cap of FIG. 19;

FIG. 22 is an illustration of a safety feature of the tablet dispenser according to one embodiment;

FIG. 23 depicts a tablet dispenser and tablet container assembly engaged with a dock, according to one embodiment;

FIG. 24 is an exploded view of the dock of FIG. 23;

FIG. 25 illustrates removal of a tablet dispenser and tablet container assembly from a dock; and

FIG. 26 illustrates docking of a tablet dispenser and tablet container assembly to a dock.

### DETAILED DESCRIPTION

In some embodiments, devices and methods for dispensing tablets are provided. In some embodiments, the tablets are mini-tablets (also referred to as micro-tablets).

Tablets, especially mini-tablets, may be difficult to handle individually. A user may need to retrieve an exact number of tablets from a container holding a plurality of tablets in order to achieve a desired dosage. Retrieving and handling tablets may be difficult for users, especially for users having limited dexterity. Mini-tablets, which, in some embodiments, may have diameters of less than or equal to about 6 mm, can be especially challenging for users to handle. The inventors have thus recognized the need for a tablet dispenser that allows a user to select a desired dosage and dispenses the correct number of tablets to achieve the selected desired dosage.

In some conventional tablet handling devices, tablets may fall in a manner that results in the formation of an arch of tablets that bridge over an outlet through which the tablets are discharged, resulting in a jam that blocks dispensing of tablets. The inventors have thus recognized the need for a tablet dispenser that helps to discourage tablet arch formation.

The inventors have also recognized the need for safety features to help prevent unwanted access of the tablets, e.g. by children.

Accordingly, in some embodiments described herein, a tablet dispenser may address one or any combination of the aforementioned needs and shortcomings with conventional dispensers. In some embodiments, a tablet dispenser may include a dosage actuator that allows a user to select and dispense a desired dosage of tablets. In some embodiments, a tablet dispenser includes a tablet distributor that helps to discourage tablet arch formation. In some embodiments, a tablet dispenser includes one or more child safety features that discourage dispensing of tablets. However, it should be appreciated that tablet dispensers described herein are not limited to addressing the needs identified above, and may instead address needs other than those identified above.

According to one aspect, a tablet dispenser is configured to attach directly to a tablet container (e.g., a container holding a plurality of tablets). In use, a user removes a cap from the tablet container, and replaces the cap with the tablet dispenser. The tablet dispenser may have threads that cooperate with the threads of the tablet container, such that the tablet dispenser is screwed onto the tablet container to attach the tablet dispenser to the tablet container.

In some embodiments, a user may set a desired dosage on the tablet dispenser. In some embodiments, a user sets a dosage on the tablet dispenser by manipulating a dosage selector on the tablet dispenser. In some embodiments, the dosage selector is a slider. The slider may be connected to a moveable wall that is moveable within a channel. The volume of space bounded by the channel and the moveable wall may comprise a collection space that receives tablets from the tablet container. As such, the volume of the collection space may be set by the position of the slider. Thus, the position of the slider determines the number of tablets that are able to fit in the collection space. For example, movement of the slider from a larger dosage selection to a smaller dosage selection may move the moveable wall in a direction that decreases the volume of the collection space. Likewise, movement of the slider from a smaller dosage selection to a larger dosage selection may move the moveable wall in a direction that increases the volume of the collection space.

In use, with the tablet dispenser attached to the tablet container, a user may tilt or invert the tablet container such that tablets from within the container fall into the collection space by gravity. In some embodiments, a user may repeatedly tap on the tablet container to encourage tablets to exit the tablet container and enter the collection space. The tablets may continue to fall into the collection space until the collection space is filled with tablets. A user may then dispense the collected tablets out of the collection space.

In some embodiments, the tablet dispenser may include a tablet distributor between the tablet container and the collection space that may help to facilitate metered fall of tablets and/or may help to discourage tablet arch formation. In some embodiments, a tablet dispenser includes a tablet distributor with a plurality of spaced pegs. In some embodiments, the pegs may be positioned in a Galton board arrangement. The spacing between pegs may be sized to permit passage of tablets. In some embodiments, tablets exiting the tablet container may first move through the tablet distributor before entering the collection space.

In some embodiments, fluid communication between the collection space and the tablet container may be selectively opened and closed. Prior to use, fluid communication between the collection space and the tablet container may be closed. A user may open fluid communication between the collection space and the tablet container, invert or tilt the tablet container to dispense tablets into the collection space, and then close fluid communication between the collection space and the tablet container. In some embodiments, the collection space is part of a collector that is pivotally mounted to a cap of the tablet dispenser. A user may pivot the collector (and thus, the collection space) from a first configuration to a second configuration to open fluid communication between the collection space and the tablet container, and the user may pivot the collection space back to the first configuration to close fluid communication between the collection space and the tablet container. In some embodiments, when the collection space is in the first configuration, the collection space is opened to an external environment to permit dispensing of tablets in the collection space out of the tablet dispenser.

In some embodiments, a tablet dispenser may have one or more child-proof features. In some embodiments, the tablet dispenser includes a child-proof lock that blocks the collector from pivoting when the lock is engaged. In some embodiments, a dock may be provided to receive and hold a tablet dispenser engaged to a tablet container. The dock may include a child-proof clamp that serves to block removal of the tablet dispenser and tablet container from the dock.

The tablets may be a prescription or an over-the-counter medication. The tablet container may be one that a patient obtains from a pharmacy or other drugstore. The tablet dispenser may be provided to a patient with the tablet container, or separately from the tablet container. In some embodiments, the tablet dispenser is re-usable with different tablet containers. For example, after one tablet container has been depleted of tablets using the tablet dispenser, a user may subsequently use the tablet dispenser with a second tablet container. As another example, a user may use the same tablet dispenser to switch between different tablet containers, e.g. to dispense different types of tablets.

In some embodiments, the tablet dispenser is configured to dispense mini-tablets. In some embodiments, mini-tablets may have a maximum dimension (e.g., a diameter) that is less than or equal to about 4, 3.5, 3, 2.5, 2, 1.5, 1 or 0.5 millimeters (mm). In some embodiments, mini-tablets may have a maximum dimension (e.g., a diameter) that is at least about 0.5, 1, 1.5, 2, 2.5, 3, 3.5 or 4 mm. It should be understood that combinations of the above-referenced ranges are also possible. For example, in some embodiments, mini-tablets may have a maximum dimension (e.g., a diameter) of about 1 to 4 mm, 1 to 3.5 mm, 1 to 3 mm, 1 to 2.5 mm, 1 to 2 mm, 1 to 1.5 mm, 1.5 to 4 mm, 2 to 4 mm, 2.5 to 4 mm, 3 to 4 mm, 3.5 to 4 mm, 1.5 to 3 mm, 1.5 to 2.5 mm, or 1.5 to 2 mm. In some embodiments, the mini-tablets may have a cylindrical shape having a diameter and a height.

In other embodiments, the tablet dispenser is configured to dispense larger tablets. In some embodiments, tablets may have a maximum dimension of at least about 5, 6, 7, 8, 9, 10, 11, 12, 13, 14, 15, 16, 17, 18, 19, 20, 21, 22, 23, 24, or 25 mm. In some embodiments, tablets may have a maximum dimension of less than or equal to about 25, 24, 23, 22, 21, 20, 19, 18, 17, 16, 15, 14, 13, 12, 11, 10, 9, 8, 7, 6, or 5 mm. It should be understood that combinations of the above-referenced ranges are also possible. For example, in some embodiments, tablets may have a maximum dimension of about 5 to 25 mm, 5 to 20 mm, 5 to 15 mm, 5 to 10 mm, 5 to 9 mm, 5 to 8 mm, 5 to 7 mm, 5 to 6 mm, 10 to 25 mm, 15 to 25 mm, 20 to 25 mm, or 10 to 20 mm.

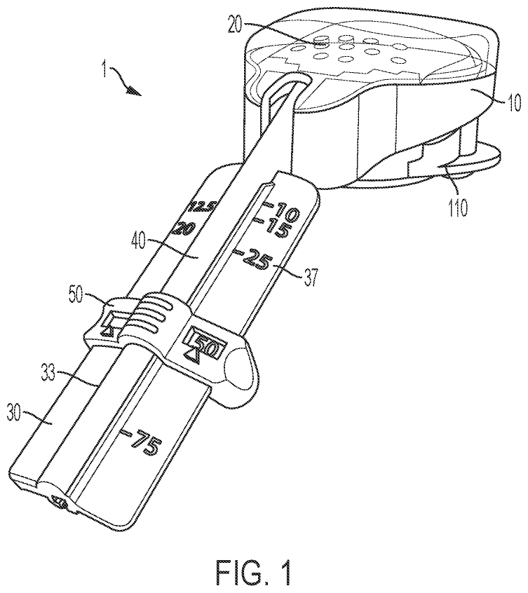

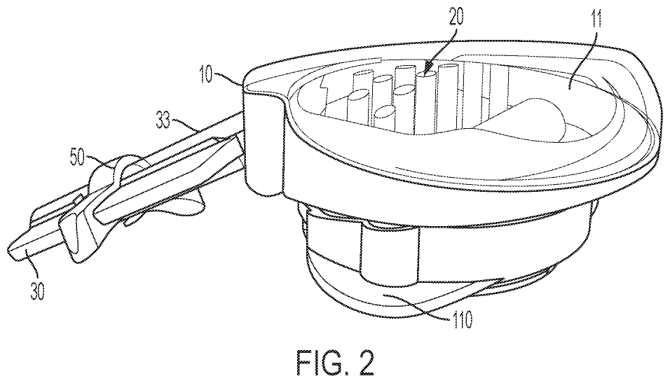

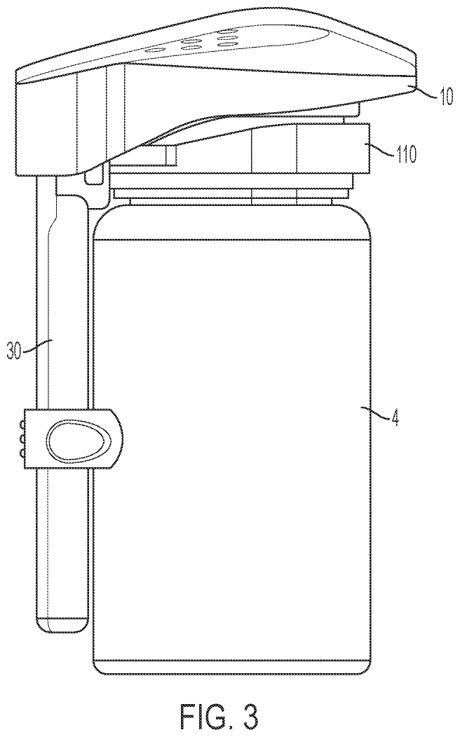

Turning to the figures, FIG. 1 is a front, right perspective view and FIG. 2 is a rear, right perspective view of one embodiment of a tablet dispenser that may be used to dispense tablets, including mini-tablets. The tablet dispenser 1 may include a cap 10, a collector 30 and a dosage actuator 50. The cap 10 may be configured to couple to a tablet container, as seen in FIG. 3. In use, tablets may exit the tablet container 4, enter the cap 10, pass through a tablet distributor 20 in the cap, enter a collection space 40 in the collector 30, and then exit the collection space out through a dispensing outlet.

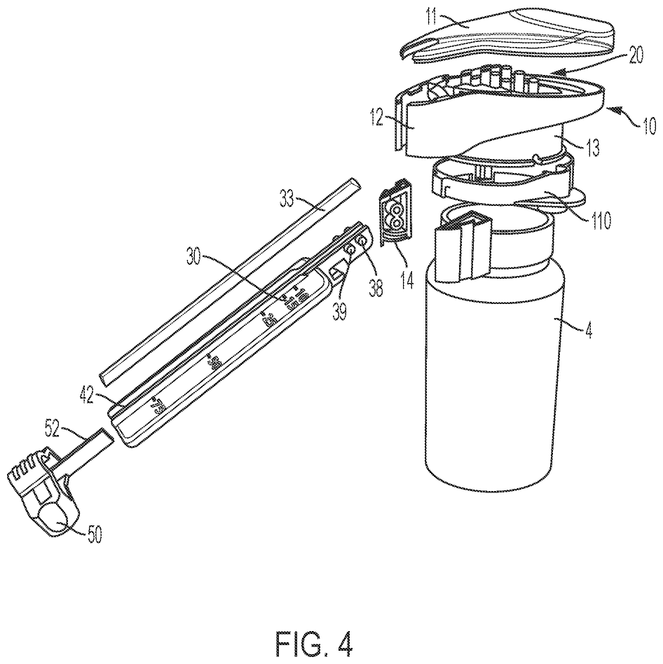

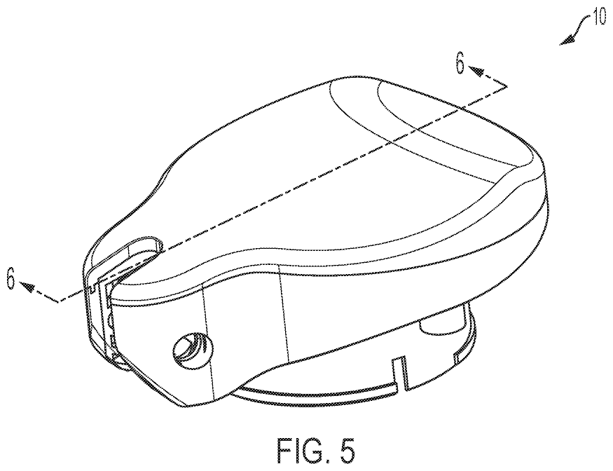

An exploded view of the tablet dispenser-tablet container assembly is shown in FIG. 4. The cap 10 may comprise a cap cover 11, a cap body 12, and a tablet distributor 20. The collector 30 may comprise a channel 42 and a covering 33 that covers the channel 42. The dosage actuator 50 may be a slider having a moveable wall 52 that is configured to slide through the channel 42. The collection space of the collector may be the volume in the channel 42 that is bounded by the covering 33 and the moveable wall 52. As such, in some embodiments, the position of the dosage actuator 50 may dictate the volume of the collection space. Actuating the dosage actuator to increase the dosage may increase the volume of the collection space, and actuating the dosage actuator to decrease the dosage may decrease the volume of the collection space.

While the dosage actuator is shown as a manual slider in the illustrative embodiment of the figures, it should be appreciated that other arrangements of the dosage actuator are possible. For example, in some embodiments, the position of the moveable wall may be controlled via a powered arrangement or stored energy arrangement, e.g. a motor, a servo, a solenoid, a pneumatic arrangement, or any other suitable arrangement. The dosage actuator need not be purely mechanical, and instead may include, for example, one or more buttons that transmit signals to a controller and/or a display such as an LCD display.

In some embodiments, the covering 33 is transparent to enable a user to see or partially see into the channel 42, e.g. to help a user determine if the collection space has been filled with tablets. In some embodiments, the covering 33 is also shaped as a magnifying lens, e.g. curved. The covering 33 may help to magnify a view of the contents within the channel 42.

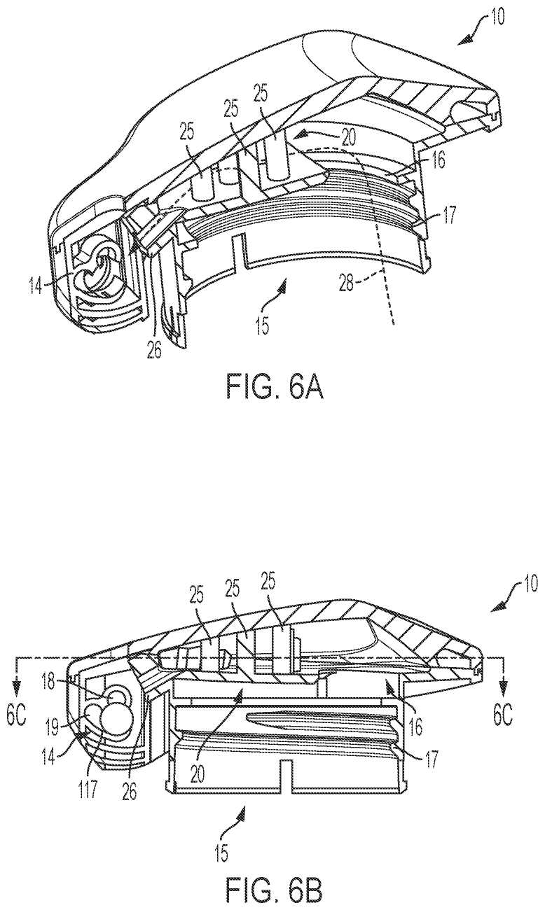

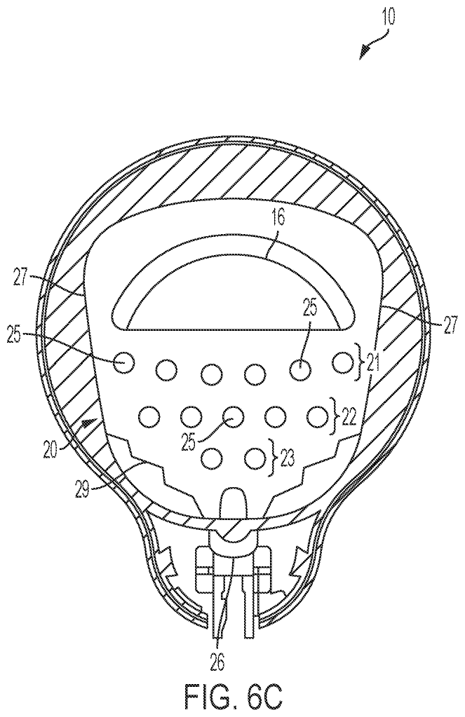

In some embodiments, the tablet dispenser may include a tablet distributor between the tablet container and the collection space that may help to facilitate metered fall of tablets and/or may help to discourage tablet arch formation. One illustrative embodiment of a tablet distributor is shown in FIGS. 6A, 6B and 6C. The tablet distributor 20 comprises a plurality of pegs 25 that are spaced from one another. The spacing between pegs may be sized to permit passage of tablets while reducing the likelihood of tablet arch formation. With the tablet dispenser coupled to a tablet container, a user tilts or inverts the tablet container to urge tablets to fall into the cap via gravity. The tablets continue to move through the cap 10 via gravity. An illustrative tablet movement path is shown in FIG. 6A. Some tablets may move along the movement path 28 from a tablet container into the cap 10 through a distributor inlet 16. The tablets then move through the tablet distributor 20 and out a cap outlet 26. The distributor inlet 16 is an intermediate opening between the opening 15 into the cap and the cap outlet 26. It should be understood that tablets may move between any of the pegs of the tablet distributor, not just the pegs that the illustrative movement path 28 passes between.

A top down view of the tablet distributor 20 is shown in FIG. 6C. Tablets move from the distributor inlet 16 toward the cap outlet 26, passing between the pegs 25 of the tablet distributor. The tablet distributor 20 illustratively includes a plurality of rows of pegs. For example, the tablet distributor 20 includes a first row of pegs 21, a second row of pegs 22, and a third row of pegs 23. Each row of pegs need not have an equal number of pegs. In some embodiments, each subsequent row of pegs moving from the distributor inlet toward the cap outlet has a decreasing number of pegs. However, in some embodiments, the rows of pegs each have an equal number of pegs, or, in some embodiments, each subsequent row of pegs moving from the distributor inlet toward the cap outlet has an increasing number of pegs. In some embodiments, the tablet distributor 20 may include sidewalls 27. In some embodiments, the distance between the sidewalls 27 decreases moving in a direction from the distributor inlet 16 toward the cap outlet 26, forming a funnel that directs tablets toward the cap outlet 26. In some embodiments, a portion of the sidewalls toward the cap outlet 26 has a jagged shape 29 that continues to funnel inwardly toward the cap outlet 26. This jagged shape 29 reduces the likelihood of tablet arch formation or otherwise serves to prevent tablets from stagnating within the tablet distributor during a dispensing operation.

In some embodiments, adjacent rows of pegs are staggered from one another. For example, the second row of pegs 22 may be staggered from the first row of pegs 21, and the third row of pegs 23 may be staggered from the second row of pegs 22. In some embodiments, alternating rows of pegs are aligned with one another. For example, the two pegs of the third row of pegs 23 may be aligned with two of the pegs of the first row of pegs 21. In some embodiments, such as in the illustrative embodiment of FIG. 6C, the pegs of the tablet distributor form a quincunx or “Galton Board” arrangement.

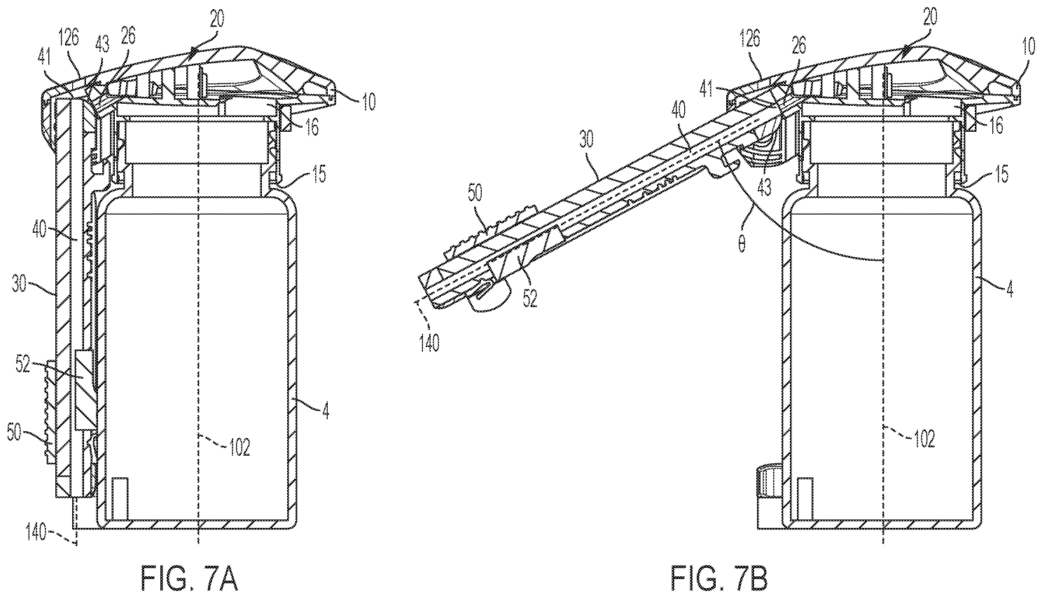

In some embodiments, tablets exiting the tablet dispenser cap may enter a collection space of a collector. According to one aspect, fluid communication between the collection space and the tablet dispenser cap (and the tablet container) may be selectively opened and closed. As shown in the illustrative embodiment of FIGS. 7A and 7B, control of fluid communication between the collection space and the tablet container is accomplished via a rotational position of the collector 30 relative to the cap 10. The collector 30 has a first configuration illustrated in FIG. 7A, and a second configuration illustrated in FIG. 7B. When the collector 30 (and thus the collection space 40) is in the first configuration, fluid communication between the collection space 40 and the cap 10 is closed. In some embodiments, when the collector 30 (and thus the collection space 40) is in the first configuration, fluid communication between the collection space 40 and the tablet container 4 is closed. As shown in FIG. 7A, in the first configuration, an opening 41 into the collection space 40 is misaligned from the cap outlet 26. In the first configuration, a shoulder 43 of the collector 30 is adjacent the cap outlet 26, thus blocking tablets from exiting the cap outlet 26.

In the second configuration, also referred to herein as a collection configuration, illustrated in FIG. 7B, the collector 30 has been rotated away from the container tablet 4. When the collector 30 (and thus the collection space 40) is in the second configuration, fluid communication between the collection space 40 and the cap 10 is opened. In some embodiments, when the collector 30 (and thus the collection space 40) is in the second configuration, fluid communication between the collection space 40 and the tablet container 4 is opened. As shown in FIG. 7B, in the second configuration, the opening 41 into the collection space 40 is aligned with the cap outlet 26, thus opening fluid communication between the collection space 40 and the cap 10, and between the collection space 40 and the tablet container 4. In the second configuration, the shoulder 43 of the collector 30 has moved to a position that no longer obstructs the cap outlet 26. When the collector 30 is in the second configuration, tablets from the tablet container 4 may pass through the cap 10 and into the collection space 40.

In some embodiments, when the collector 30 is in the first configuration, a longitudinal axis 140 of the collection space 40 is parallel to a longitudinal axis 102 of the cap opening 15 (which, in some embodiments, may also coincide with a longitudinal axis of the tablet container 4). In some embodiments, when the collector 30 is in the second configuration, the longitudinal axis 140 of the collection space 40 is at an angle θ relative to the longitudinal axis 102 of the cap opening 15 (which, in some embodiments, may also coincide with a longitudinal axis of the tablet container 4). In some embodiments, the angle θ is at least about 10, 20, 30, 35, 40, 45, 50, 55, 60, 65, 70, 75, 80, 85, 90, 100, 120, 140, 160, 180 or 200 degrees. In some embodiments, the angle θ is less than or equal to about 200, 180, 160, 140, 120, 100, 90, 85, 80, 75, 70, 65, 60, 55, 50, 45, 40, 35, 30, 20, or 10 degrees. Combinations of the above-referenced ranges are also possible. For example, in some embodiments, the angle θ is about 10 degrees to about 200 degrees, about 20 degrees to about 160 degrees, about 30 degrees to about 90 degrees, about 35 degrees to about 70 degrees, or about 40 degrees to about 60 degrees.

In some embodiments, the collector 30 may be rotatably mounted to the cap 10. As shown in FIG. 4, the collector 30 may include a pivot pin 38 and a sweep pin 39 that are received by a hinge 14 of the cap 10. As shown in FIG. 6B, the hinge 14 may include a first barrel 18 and a second barrel 19, where the second barrel 19 has an extended sweep path 117. The first barrel 18 may receive the pivot pin 38, and the second barrel 19 may receive the sweep pin 39. The collector may rotate relative to the cap 10 about the pivot pin 38. During rotation of the collector 30 relative to the cap 10, the pivot pin 38 may rotate within the first barrel 18, while the sweep pin 39 may both rotate and translate. When the collector 30 is moved from the first configuration to the second configuration, the sweep pin 39 moves through the extended sweep path 117 and enters the second barrel 19. When the collector 30 is moved from the second configuration to the first configuration, the sweep pin 39 moves out of the second barrel 19 and through the extended sweep path 117.

In some embodiments, after the tablets enter a collection space, the tablets in the collection space are dispensed out of the tablet dispenser. In some embodiments, the tablets are blocked from exiting the collection space until a user actuates the tablet dispenser into a dispensing configuration. In some embodiments, the collector is in a certain rotational position when the tablet dispenser is in the dispensing configuration.

In some embodiments, the dispensing configuration is the same as the first configuration described above and shown in FIG. 7A. As illustrated in FIG. 7A, when the collector 30 is in the first configuration, the opening 41 into the collection space 40 is aligned with a dispenser outlet 126, which may be a through-hole in the cap 10. Inverting the tablet dispenser-tablet container assembly when the collector 30 is in the first configuration may cause tablets collected in the collection space 40 to fall out of the collection space 40 and through the dispenser outlet 126, thereby exiting the tablet dispenser. In some embodiments, fluid communication between the collection space and the dispenser outlet may be selectively opened and closed. When the collector 30 is in the second configuration, as shown in FIG. 7B, fluid communication between the collection space 40 and the dispenser outlet 126 is closed. When the collector 30 is in the first configuration, as shown in FIG. 7A, fluid communication between the collection space 40 and the dispenser outlet 126 is opened.

It should be appreciated that, in some embodiments, a dispenser outlet 126 that is separate and distinct from the opening 41 into the collection space 40 may not be necessary. In some embodiments, the opening 41 into the collection space 40 itself may serve as a dispenser outlet.

It should also be appreciated that the dispensing configuration need not be the same as the first configuration. In some embodiments, the dispensing configuration and the first configuration are separate and distinct configurations. For example, in some embodiments, in the dispensing configuration, the collector is at a different position (e.g., different rotational position) relative to the tablet dispenser cap than in the first and second configurations.

In some embodiments, a dispenser outlet valve or other covering is included to permit one-way movement of objects through the dispenser outlet (e.g. tablets are permitted to exit the tablet dispenser through the dispenser outlet, but objects external to the tablet dispenser are not permitted or discouraged from entering the dispenser outlet.) One example of a dispenser outlet valve is a flap that opens in only one direction, such as a living hinge or other hinged component. The dispenser outlet valve or other covering may be positioned at or near the dispenser outlet.

In some embodiments, to place the tablet dispenser in a dispensing configuration, a user interacts with an actuator to open a dispenser outlet. For example, a user may push a button that causes a dispenser outlet to be uncovered. Or, a user may slide a dispenser outlet covering from a closed position to an opened position.

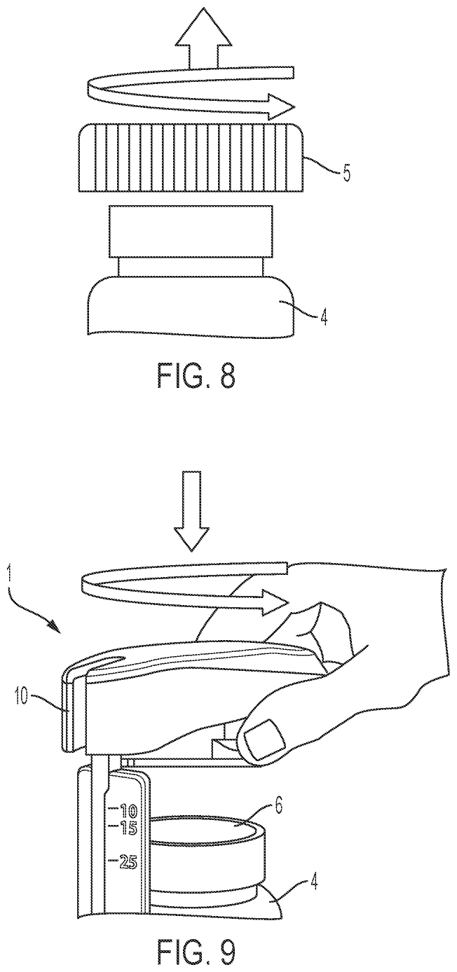

One embodiment of a sequence of operational steps involved in dispensing tablets from a dispenser tablet will now be discussed in reference to FIGS. 8-16. Referring to the exemplary embodiment in FIGS. 8-16, a user is provided with a tablet container 4 having an associated tablet container cap 5, as illustrated in FIG. 8. The user removes the tablet container cap 5 from the tablet container 4 by unscrewing and lifting the tablet container cap 5 from the tablet container 4. The user replaces the tablet container cap 5 with the cap 10 of the tablet dispenser 1. As illustrated in FIG. 9, the cap 10 of the tablet dispenser attaches to the tablet container 4 by lowering the cap 10 onto the tablet container 4 and screwing the cap 10 onto the tablet container 4, thus covering the opening 6 of the tablet container with the tablet dispenser cap 10. As illustrated in FIGS. 6A and 6B, the cap 10 may include threads 17 for engaging with threads of a tablet container.

The tablet dispenser of FIG. 9 is illustrated in a first configuration, in which fluid communication between the collection space and the cap is closed. After the tablet dispenser is coupled to the tablet container, fluid communication between the collection space and the tablet container is also closed when the tablet dispenser is in the first configuration.

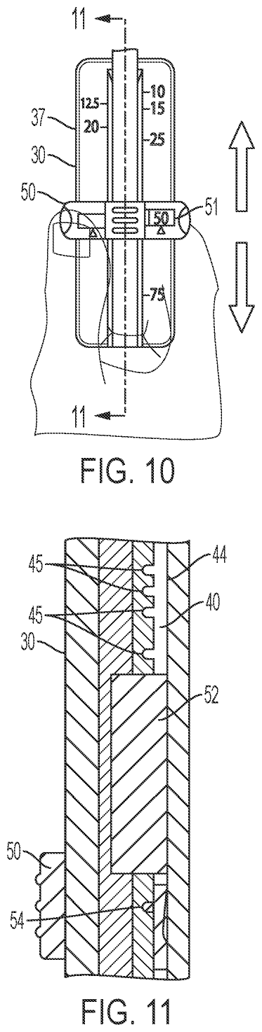

FIGS. 10 and 11 illustrate how, according to some embodiments, a user may select a desired dosage. The collector 30 includes a plurality of indicia 37 that indicate different dosages. The user slides the dosage actuator 50, e.g. manually, until a window 51 of the dosage actuator overlies a desired dosage indicium.

As illustrated in the cross-sectional view of FIG. 11, a moveable wall 52 is coupled to the dosage actuator 50, such that movement of the dosage actuator 50 also moves the moveable wall 52. The moveable wall 52 is configured to move through the channel 44 of the collector 30. The moveable wall 52 defines a lower boundary of the collection space 40, and thus the position of the moveable wall 52 defines a volume of the collection space 40. Movement of the dosage actuator 50 towards the indicia of smaller dosages decreases the volume of the collection space 40, and movement of the dosage actuator 50 towards the indicia of larger dosages increases the volume of the collection space 40.

In some embodiments, the dosage actuator may include tactile feedback elements to assist in dosage selection. As illustrated in FIG. 11, a plurality of indentations 45 and a protrusion 54 coupled to the dosage actuator 50 interact to form a detent. The indentations 45 are illustratively positioned along the channel 44 of the collector 30, and each indentation is aligned with a corresponding dosage indicium. When the protrusion 54 enters an indentation, a user may sense (e.g., feel and/or hear) the protrusion click into place, giving the user tactile and/or audible feedback of a dosage selection. Engagement between an indentation and the protrusion holds the dosage actuator in place until a threshold force applied to the dosage actuator is exceeded. Such an arrangement may reduce the likelihood of inadvertent dosage changes.

In some embodiments, the dosage actuator 50, moveable wall 52, and protrusion 54 are integrally formed with one another. As used herein, parts that are “integrally formed” with one another are formed as one component such that they are formed from a single monolithic component, e.g., cast at the same time as a single piece such as in die casting or injection molding, or cut from a single material such as in stamping or die cutting. In other embodiments, the dosage actuator, moveable wall and protrusion are separately formed and subsequently attached to one another. Any combination of these manufacturing arrangements may be used as well, e.g. two of the three components are integrally formed with one another, and the third is later attached.

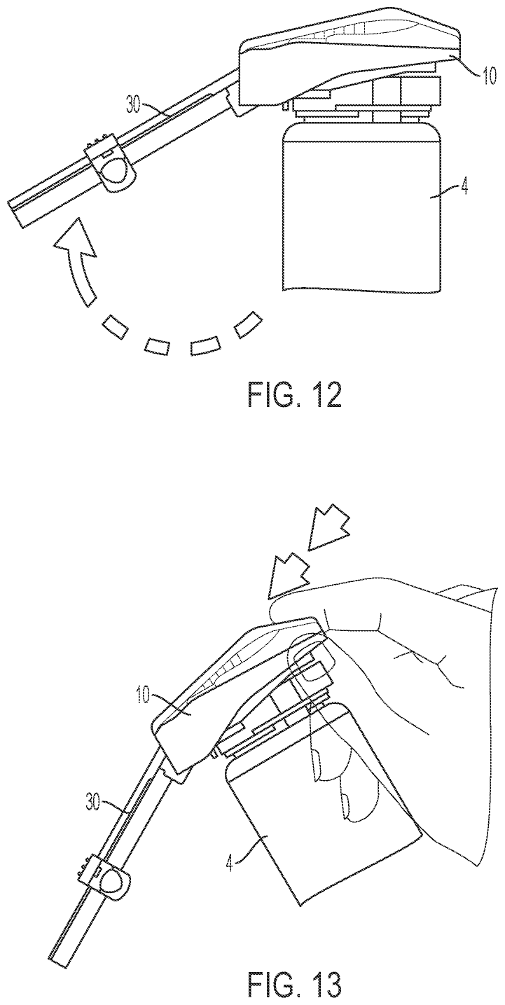

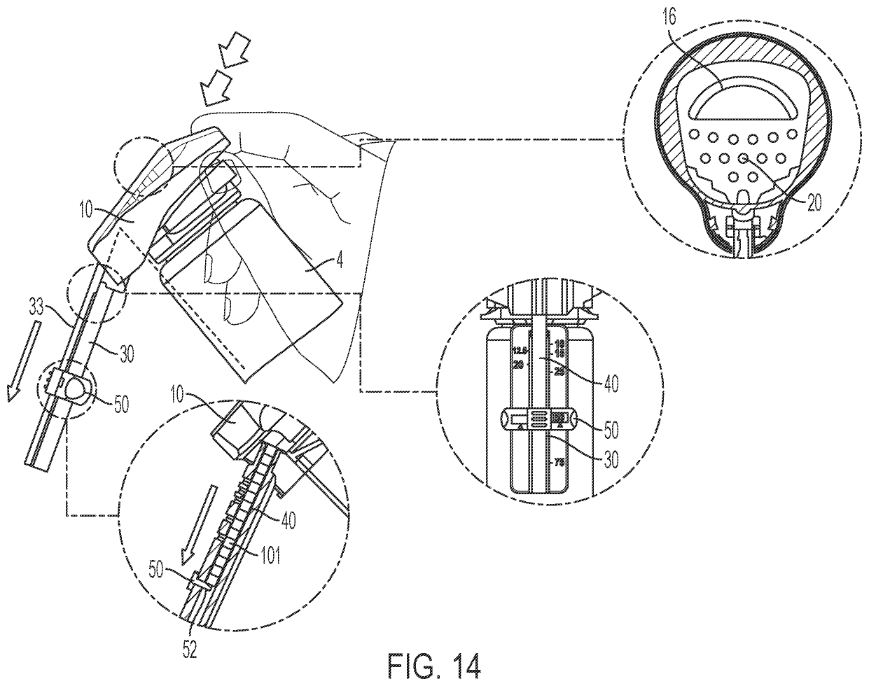

After selecting a dosage using the dosage actuator, a user may urge the tablets from the tablet container to enter the collection space. As illustrated in FIG. 12, first a user rotates the collector 30 relative to the tablet dispenser cap 10 in a direction away from the tablet container 4, thus placing the tablet dispenser in the second configuration. As discussed previously, rotation of the collector 30 into the second configuration opens fluid communication between the cap 10 and the collection space of the collector. Next, as illustrated in FIG. 13, a user may tilt the tablet container and tablet dispenser assembly to allow tablets inside the tablet container to fall into the cap 10 via gravity. In some embodiments, a user taps on the cap 10 and/or the tablet container 4 to urge tablets to move from the tablet container 4 into the cap 10, to urge tablets through the tablet distributor in the cap 10, to urge tablets to move from the cap 10 into the collection space of the collector 30, or any combination of the above. In some embodiments, the tapping action is oriented in a direction that is toward the cap outlet to encourage tablets to enter the collection space. Further detail of the tablet movement pathway is illustrated in FIG. 14. First, tablets move from the tablet container 4 into the cap 10 of the tablet dispenser. The tablets pass through a distributor inlet 16 and enter the tablet distributor 20, which may comprise a plurality of spaced pegs as discussed above. The tablets are then urged to move through the tablet distributor 20, e.g., due to a user tilting the tablet dispenser and tablet container assembly forward and tapping on the cap 10 and/or the tablet container 4, as illustrated in FIG. 14. The tablets subsequently exit the cap 10 and enter a collection space 40 of the collector 30. FIG. 14 depicts an array of tablets 101 that have entered the collection space 40. In some embodiments, the depth of the collection space 40 is bounded by a moveable wall 52, and the position of the moveable wall 52 is set by the position of the dosage actuator 50.

A user may continue to tap or otherwise urge tablets into the collection space until the collection space has filled with tablets. In some embodiments, a user may visually confirm that the collection space has been filled with tablets. As discussed herein, the covering 33 of the collector may be transparent to enable a user to see or partially see into the collection space 40 to visually verify that the collection space has been filled. In some embodiments, the covering 33 is shaped to provide an optical magnifying effect to help a user better visualize the contents inside the collection space.

In some embodiments, the collection space is sized to encourage the tablets to form a single-file line within the collection space (e.g., a linear array of tablets). In some embodiments, the width of the collection space is only slightly larger than a width or a diameter of the tablets. In some embodiments, the width of the collection space is within at least about 1, 2, 3, 4, 5, 6, 7, 8, 9, 10, 11, 12, 13, 14, 15, 16, 17, 18, 19, 20, 21, 22, 23, 24, or 25 percent of the width of the tablets. In some embodiments, the width of the collection space is within less than or equal to about 25, 24, 23, 22, 21, 20, 19, 18, 17, 16, 15, 14, 13, 12, 11, 10, 9, 8, 7, 6, 5, 4, 3, 2, or 1 percent of the width of the tablets. It should be understood that combinations of the above-referenced ranges are also possible. For example, in some embodiments, the width of the collection space is within at least about 1 to 25, 5 to 20, 10 to 15, 5 to 10, or 1 to 10 percent of the width of the tablets.

It should be appreciated that the collection space need not be sized to encourage the tablets to form a linear array. Instead, the collection space may be sized to allow the tablets to fill the space in any suitable arrangement, such as a plurality of rows of tablets, or a collection of tablets that do not form an organized arrangement.

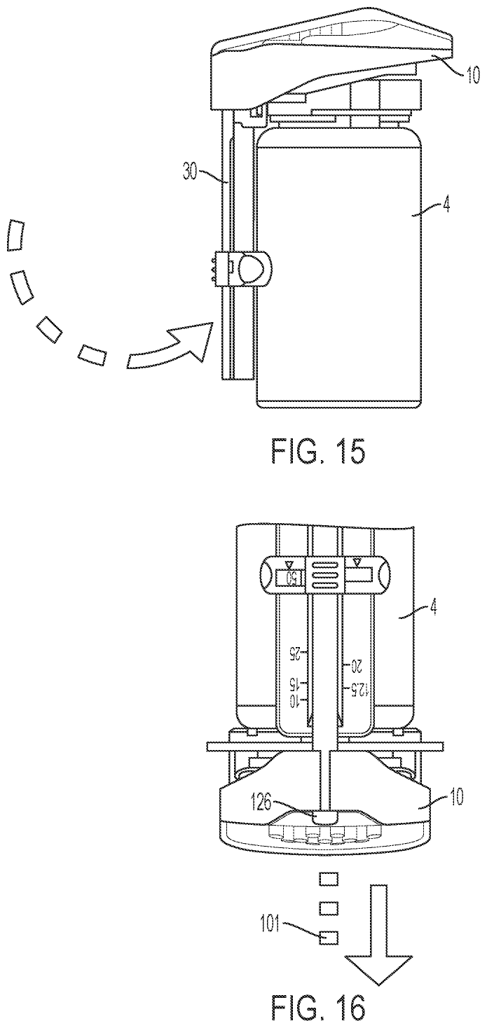

After the collection space is filled with the desired number of tablets, the tablets may then be dispensed out of the collection space and out of the tablet dispenser. As illustrated in FIG. 15, a user may rotate the collector 30 back towards container 4 into a dispensing configuration. A user may then invert the tablet dispenser-tablet container assembly to dispense the tablets 101 out of the dispenser outlet 126, as shown in FIG. 16.

In the illustrative embodiment of FIG. 15, the dispensing configuration of the tablet dispenser is the same as the first configuration shown in FIG. 9, in which fluid communication between the tablet container and the collection space is closed.

According to one aspect, a tablet dispenser may include one or more safety features that may require specific actions to unlock. The safety features prevent or reduce the likelihood of inadvertent dispensing of tablets and/or unwanted access to the tablets, e.g. by children. In some embodiments, the action(s) required to unlock the safety feature(s) may be more difficult for a child than for an adult to perform.

In some embodiments, a safety feature maintains closed fluid communication between the tablet dispenser cap/tablet container and the collection space. In some embodiments, the safety feature accomplishes such an arrangement by blocking rotation of the collector relative to the tablet dispenser cap until the user unlocks the safety feature.

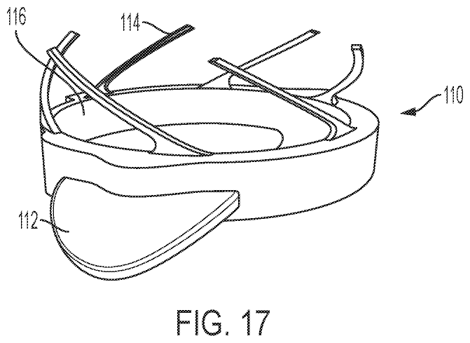

An illustrative embodiment of a safety lock 110 is illustrated in FIG. 17. Safety interlock 110 is also illustratively integrated with a tablet dispenser in other figures, such as FIGS. 3 and 4. The safety lock 110 includes a ring 116 that is sized to fit around a collar 13 of the cap 10 (see, e.g. FIG. 4 for collar 13). The safety lock 110 illustratively includes a compressible spring coupled to the ring 116. In the illustrative embodiment of FIG. 17, the spring comprises a plurality of spring arms 114. The ring 116 and the spring arms 114 are integrally formed together in the illustrative embodiment. The safety lock 110 may also include wings 112 that a user may interact with to unlock the safety lock.

While the illustrative embodiment shown in the figures includes spring arms for the safety lock spring, other arrangements for the spring may be used, as this aspect is not so limited. For example, the spring may be a coil spring, a leaf spring, compressible foam, or any other suitable spring. The spring need not be integrated with the safety lock component, and instead may be a separate and distinct component positioned between the safety lock and the cap.

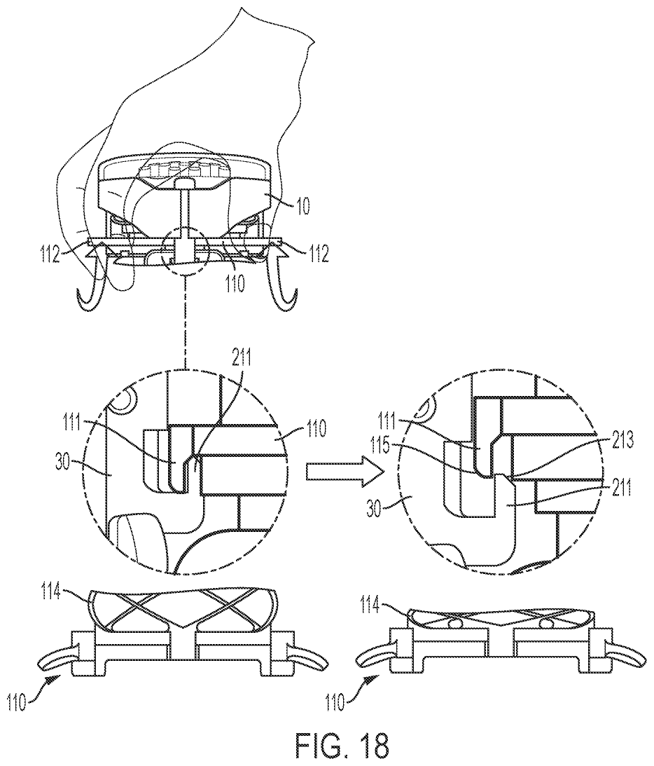

An exemplary operation of the safety lock 110 is illustrated FIG. 18. A user lifts or pulls up on the safety lock 110 by pulling the wings 112 in a direction away from the container 4. Lifting the safety lock 110 results in a tab 111 on the safety lock clearing a catch 211 on the collector 30, thus freeing the collector 30 to rotate relative to the cap 10. Lifting of the safety lock 110 compresses the spring arms 114 against the cap 10. The spring arms 114 are shown in a compressed state in the lower right portion of FIG. 18. When a user ceases exerting force on the safety lock 110, the spring arms 114 decompress and urge the safety lock back into the locked configuration. The spring arms 114 are shown in a decompressed state on the left side of FIG. 18. As such, the spring arms 114 bias the safety lock 110 in a locked position.

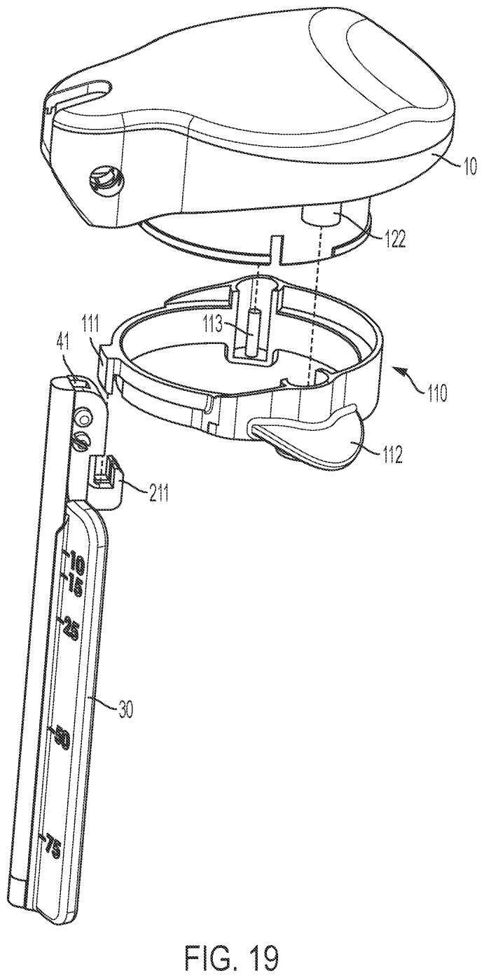

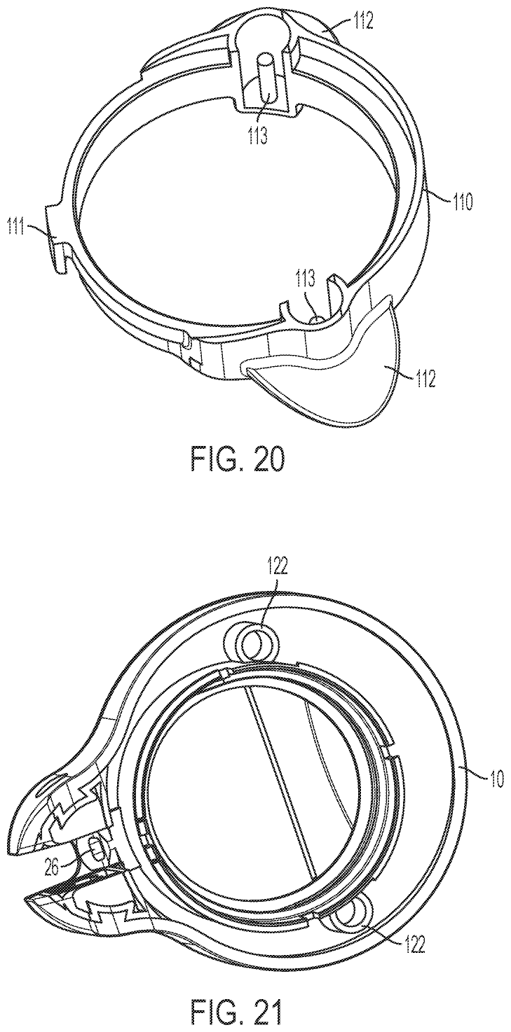

In some embodiments, the safety lock and collector may be configured to return to a locked configuration without requiring the user to interact directly with the safety lock. As illustrated in FIG. 18, the catch 211 on the collector 30 includes a sloped surface 213, and the tab 111 on the safety lock 110 includes a curved surface 115. As the collector 30 is rotated back toward the first configuration (in some embodiments, also the dispensing configuration), the sloped surface 213 of the collector catch 211 slide against the curved surface 115 of the safety lock tab 111, pushing the safety lock 110 up and causing the spring arms 114 to compress. The catch 211 then clears the tab 111, and the collector 30 is permitted to move back into the first configuration. In some embodiments, a tactile and/or audible click can be felt/heard when the collector 30 returns to the first configuration. The exploded view of FIG. 19 illustrates the interaction between the safety lock 110, cap 10, and collector 30 (the spring arms of the safety lock 110 are hidden for clarity). In some embodiments, the safety lock 110 includes guide pins 113 that are sized to fit within bosses 122 of the cap 10. These guide pins help to guide linear movement of the safety lock 110 relative to the cap 10 as the safety lock 110 is lifted up toward the cap 10. The guide pins 113 are also shown in FIG. 20, in which the spring arms of the safety lock 110 are hidden for clarity. The bosses 122 are also shown in FIG. 21, which depicts an underside of the cap 10.

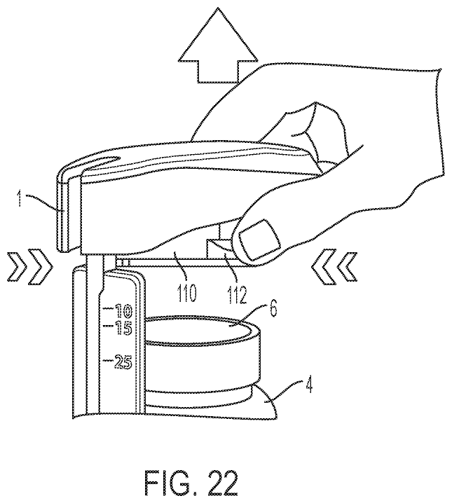

In one embodiment, the safety lock is configured to reduce the likelihood of inadvertent detachment of the tablet dispenser from the tablet container. In this embodiment, the safety lock is deformable by a squeezing force to allow attachment features of the dispenser 1 to detach from the container 4. As illustrated in FIG. 22, to detach the tablet dispenser 1 from the tablet container 4, a user squeezes radially inwardly and pull on the safety lock away from the tablet container 4.

In some embodiments, a dock is provided to reduce the likelihood of inadvertent dispensing of tablets from the tablet dispenser. The dock is configured to receive and hold a tablet dispenser and tablet container assembly. In some embodiments, the dock includes a clamp that helps prevent removal of the tablet dispenser and tablet container assembly from the dock and helps prevent removal of the tablet dispenser from the tablet container. In some embodiments, release of the clamp may require an amount of force that would be difficult for a child to administer.

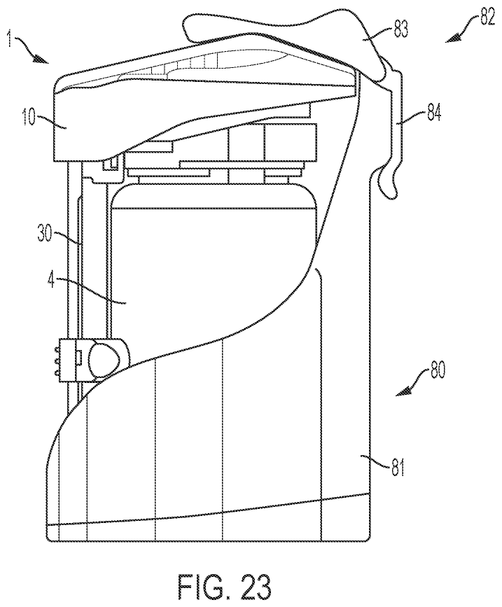

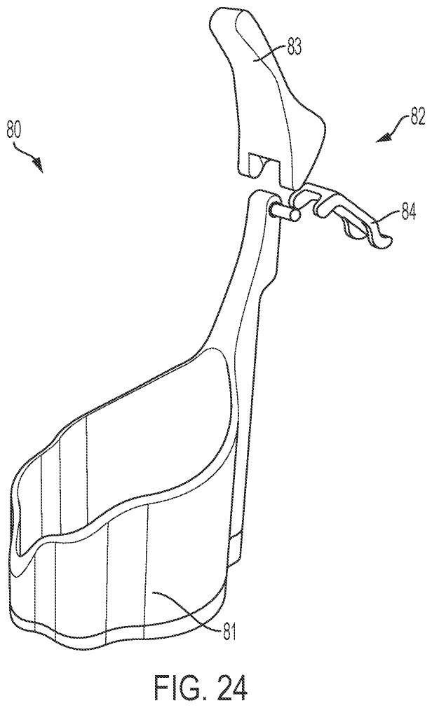

One illustrative embodiment of a dock is illustrated in FIG. 23. The dock 80 is engaged with a tablet dispenser and tablet container assembly. The dock includes a holder 81 and a toggle clamp 82, where the toggle clamp 82 comprises a lock arm 83 and a clamp 84. The holder 81 receives at least a portion of the tablet container 4. The lock arm 83 of the toggle clamp contacts a portion of the cap 10 of the tablet dispenser 1. The toggle clamp 82 blocks removal of the tablet dispenser and tablet container assembly from the holder 81. An exploded view of the dock shown in FIG. 24 illustrates the various components of the dock.

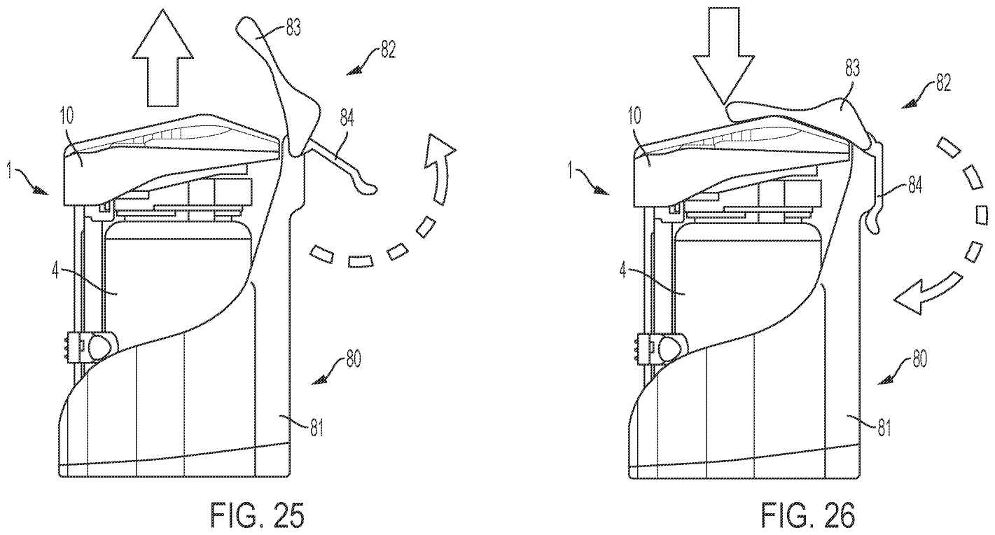

FIGS. 25 and 26 illustrate operation of the dock. To remove the tablet dispenser and tablet container assembly from the dock, a user releases the toggle clamp by rotating the clamp 84 upward as shown in FIG. 25. Disengaging the clamp 84 frees the lock arm 83 to rotate from the tablet dispenser, freeing the tablet dispenser and tablet container assembly for removal from the dock. A threshold force may be required to release the toggle clamp. In some embodiments, the threshold force is at least about 10-15 Newtons, although other suitable threshold forces may be implemented.

To dock the tablet dispenser and tablet container assembly, the assembly is inserted into the holder 81. A user locks the toggle clamp by rotating the clamp 84 downward as illustrated in FIG. 26, which causes the lock arm 83 to clamp downward onto the cap of the tablet dispenser. In some embodiments, the tablet dispenser must be placed in the first configuration (e.g. in which fluid communication between the tablet container and the collection space is closed) before the tablet dispenser and tablet container assembly can be secured to the dock.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A tablet dispenser, comprising:
a cap configured to attach to a tablet container;
a collection space coupled to the cap and configured to receive tablets from the tablet container, the collection space having a volume that is adjustable; and
a dosage actuator, wherein actuation of the dosage actuator to change a selected dosage changes the volume of the collection space.

2. The tablet dispenser of claim 1, wherein the dosage actuator comprises a slider that is configured to slide relative to the collection space.

3. The tablet dispenser of claim 2, wherein the volume of the collection space is partially bounded by a moveable wall, the moveable wall being connected to the slider.

4. The tablet dispenser of claim 1, wherein the collection space has a first configuration in which fluid communication between the collection space and the cap is closed, and a second configuration in which fluid communication between the collection space and the cap is opened.

5. The tablet dispenser of claim 4, wherein the collection space is part of a collector arm, and the collector arm is pivotally mounted to the cap, wherein the collector arm is configured to pivot relative to the cap between the first configuration and the second configuration.

6. The tablet dispenser of claim 5, further comprising a safety lock having a locked configuration and an unlocked configuration, wherein in the locked configuration, the safety lock prohibits pivoting of the collector arm relative to the cap, and in the unlocked configuration, the collector arm is free to pivot relative to the cap.

7. The tablet dispenser of claim 1, further comprising:
an opening in the cap configured to receive tablets from the tablet container;
an outlet through which tablets are dispensed from the cap;
a pathway within the cap, the pathway connecting the opening to the outlet; and
a plurality of pegs positioned in the pathway.

8. A dock configured to receive the tablet dispenser of claim 1 while the tablet dispenser is attached to a tablet container, the dock having a clamp that prevents removal of the tablet dispenser from the dock.

9. A tablet dispenser, comprising:
a cap configured to attach to a tablet container, the cap having an opening configured to receive tablets from the tablet container;
an outlet through which tablets are dispensed from the cap;
a pathway within the cap, the pathway connecting the opening to the outlet; and
a plurality of pegs positioned in the pathway.

10. The tablet dispenser of claim 9, wherein the plurality of pegs include a first row of pegs and a second row of pegs, the first row of pegs being staggered relative to the second row of pegs.

11. The tablet dispenser of claim 10, wherein the plurality of pegs form a Galton Board arrangement.

12. The tablet dispenser of claim 9, wherein the pegs are evenly spaced.

13. The tablet dispenser of claim 9, wherein the cap includes threads configured to engage with threads of a tablet container.

14. The tablet dispenser of claim 9, further comprising sidewalls along at least a portion of the pathway, the sidewalls forming a funnel that tapers in a direction from the opening toward the outlet.

15. A method of dispensing a tablet from a tablet dispenser, comprising:
coupling the tablet dispenser to a tablet container;
setting a dosage using a dosage actuator to set a volume of a collection space;
tilting the tablet dispenser while the tablet container is attached to the tablet dispenser to permit a tablet to move from the tablet container to the collection space; and
dispensing the tablet from the collection space out of the tablet dispenser.

16. The method of claim 15, further comprising tapping the tablet dispenser or the tablet container to urge the tablet into the collection space.

17. The method of claim 15, further comprising removing a cap from a tablet container prior to coupling the tablet dispenser to the tablet container.

18. The method of claim 15, further comprising rotating the collection space relative to the tablet container to open fluid communication between the tablet container and the collection space.

19. The method of claim 18, further comprising rotating the collection space relative to the tablet container to close fluid communication between the tablet container and the collection space.

20. The method of claim 15, wherein setting the dosage comprises sliding a moveable wall that partially bounds the volume of the collection space.
